(19) United States
(12) Patent Application Publication
(10) Pub. No.: US 2019/0308566 A1
(43) Pub. Date: Oct. 10, 2019

(54) MOTOR VEHICLE TRIM COMPONENT

(71) Applicants: TREVES PRODUCTS, SERVICES & INNOVATION, Paris (FR); HONDA MOTOR CO., LTD., Tokyo (JP)

(72) Inventors: Christophe BLOM, Reims (FR); Gini PSYMOULI, South Marston Swindon Wiltshire (GB); Jorge RODRIGUEZ, South Marston Swindon Wiltshire (GB)

(21) Appl. No.: 16/470,340

(22) PCT Filed: Dec. 19, 2017
(86) PCT No.: PCT/FR2017/053683

§ 371 Date: Jun. 17, 2019

(30) Foreign Application Priority Data
Dec. 20, 2016 (FR) 1662901

(51) Int. Cl. B60R 13/02

(52) U.S. Cl. CPC B60R 13/0206; B60R 2013/0293

(57) ABSTRACT

The invention relates to a trim component having a strap and a mounting for the strap. The trim component includes a rod and an anchor head protruding radially from the rod with a housing concealing the strap end, and the housing including a bottom wall provided with an opening for passing the rod, and permitting the head to be urged against the wall. The housing includes overhanging walls extending vertically in line with the bottom wall, having a space for accommodating the head and a cover for closing the space in order to conceal the head.

### CROSS-REFERENCE TO RELATED APPLICATION

This application claims the benefit of International application number PCT/FR2017/053683, filed Dec. 19, 2017 and French application number 1662901, filed Dec. 20, 2016 the entire contents of which are incorporated herein by reference.

### TECHNICAL FIELD

The invention relates to a motor vehicle trim component.

### BACKGROUND

It is known to produce a motor vehicle trim component, such as a false floor, a side trim or a luggage compartment cover, the component comprising:
a strap, for example forming a handle or a hinge between two panels,
a mounting for the strap, for example in panel form,
a means for assembling one end of the strap to the mounting, the means being provided with a rod and an anchor head protruding radially from the rod, the means being particularly in screw or rivet form.

With such an arrangement, the end of the strap and the assembly means are visible, which may prove to lack aesthetic appeal.

### SUMMARY OF THE INVENTION

The aim of the invention is that of remedying these drawbacks.

To this end, the invention proposes a motor vehicle trim component, the component comprising:
a strap,
a mounting for the strap,
a means for assembling one end of the strap to the mounting, the means being provided with a rod and an anchor head protruding radially from the rod,
the component further comprising a housing concealing the end, the housing comprising:
   a bottom wall provided with an opening for passing the rod, the head being urged against the wall,
   overhanging walls extending vertically in line with the bottom wall, so as to define a space for accommodating the head,
   a cover for closing the space in order to conceal the head.

With the proposed arrangement, the strap and the assembly means are concealed by the housing, the shape and material thereof may be optimised to blend in optimally with the rest of the component.

### BRIEF DESCRIPTION OF THE DRAWING

Further specificities and advantages of the invention will emerge in the following description, made with reference to the appended figures wherein:

FIGS. 1a and 1b are partial schematic views of a component according to a first embodiment, in an exploded perspective view with the cover in the open position (FIG. 1a) and in a non-exploded sectional view with the cover in the closed position (FIG. 1b),

FIGS. 2a and 2b are partial schematic views of a component according to a second embodiment, in an exploded perspective view with the cover in the open position (FIG. 2a) and in a non-exploded sectional view with the cover in the closed position (FIG. 2b),

FIGS. 3a and 3b are partial schematic perspective (FIG. 3a) and sectional (FIG. 3b) views of a component according to an embodiment applicable to the embodiments in FIGS. 1 and 2.

### DETAILED DESCRIPTION

With reference to the figures, there is described a motor vehicle trim component 1, such as a false floor, a side trim or a luggage compartment cover, the component comprising:
a strap 2, for example forming a handle or a hinge between two panels,
a mounting 3 for the strap, for example in panel form,
a means 4 for assembling one end 15 of the strap to the mounting, the means being provided with a rod 5 and an anchor head 6 protruding radially from the rod, the means being particularly in screw form, according to the embodiments shown, or rivet form, in a manner not shown,
the component further comprising a housing 7 concealing the end, the housing comprising:
   a bottom wall 8 provided with an opening 9 for passing the rod, the head being urged against the wall,
   overhanging walls 10 extending vertically in line with the bottom wall, so as to define a space 11 for accommodating the head,
   a cover 12 for closing the space in order to conceal the head.

According to the embodiment shown, the housing 7 comprises interlocking means 13 for holding the cover 12 in the closed position.

Obviously, it could be envisaged to hold the cover 12 in the closed position by any other suitable means: bonding, welding, etc.

According to the embodiments shown, the housing 7 is made of moulded plastic material, the cover 12 being connected to the rest of the housing by a thin material zone 14 obtained from the moulding, such that the zone forms a flexible hinge.

In an alternative embodiment not shown, it may be envisaged that the cover 12 be separated from the rest of the housing 7.

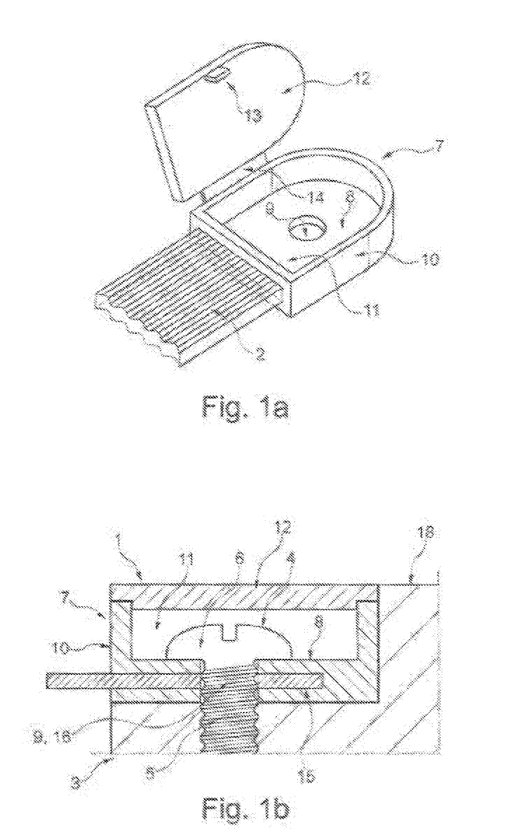

According to the embodiment shown in FIGS. 1, the housing 7 is based on moulded plastic material, the end 15 of the strap 2 being overmoulded by the housing.

In particular, the strap 2 extends on either side of the opening 9, the strap being provided with a hole 16 for passing the rod 5, such that the rod passes both via the hole and the opening, which enables a very robust assembly between the strap and the mounting 3.

In an alternative embodiment not shown, the strap 2 does not extend onto the opening 9.

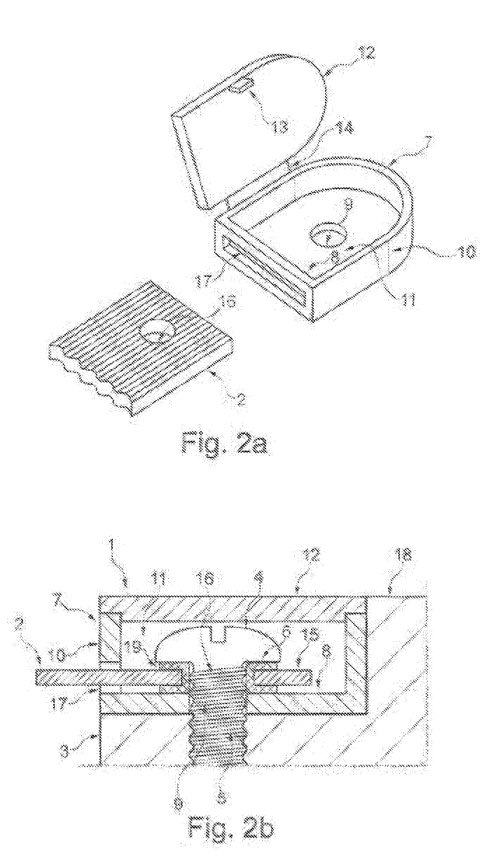

According to the embodiment shown in FIGS. 2, an overhanging wall 10 is provided with a slot 17 through which the strap 2 passes to arrange the end 15 thereof in the space 11, the strap being provided at the end thereof with a hole 16 for passing the rod 5, such that the rod passes both via the hole and the opening 9.

In particular, according to the embodiment shown, the hole 16 is provided with a reinforcement eyelet 19.

According to the embodiments shown, the cover 12 is arranged flush with a visible face 18 of the mounting 3 which is contiguous therewith, so that the housing 7 does not protrude with respect to the mounting.

It may further be envisaged, in the case of a cover 12 made of moulded plastic material, that the latter be provided with surface embossing, so as to optimise the visual appeal thereof.

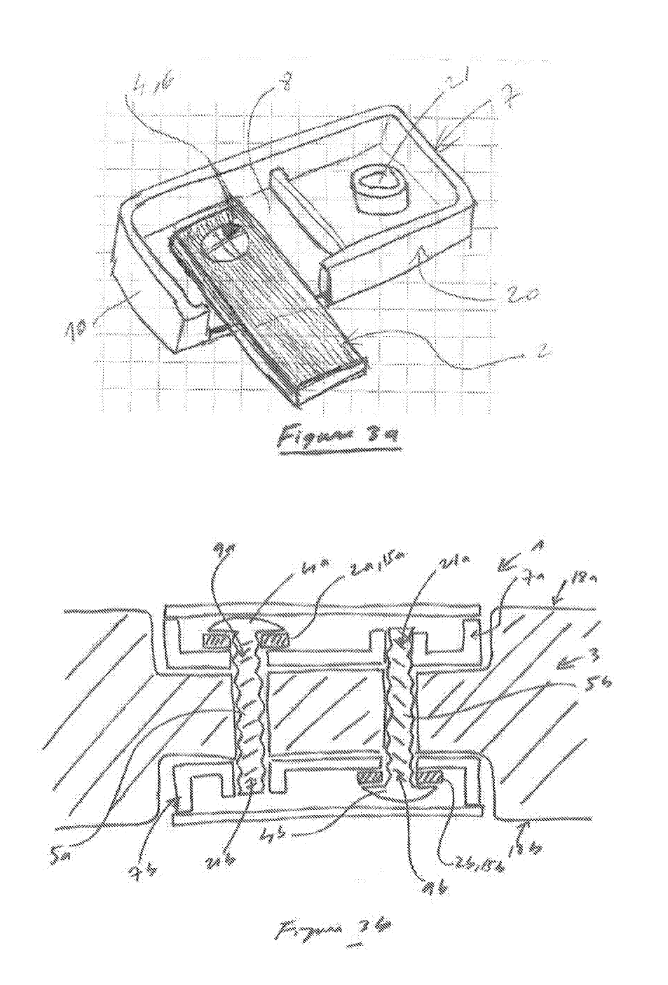

According to an embodiment shown in FIG. 3b, applicable to all the embodiments previously described and represented in the case of non-overmoulded strap 2, a housing 7 comprises a lateral protuberance 20 provided with an opening 21 for screwing a threaded rod 5 of an assembly means 4 in screw form.

The use of such a housing makes it possible, as shown in FIG. 3b, to fasten contiguously two straps 2a, 2b onto two opposite visible faces 18a, 18b of a mounting 3.

Such a manner of proceeding makes it possible particularly, in a manner not shown, to join together two mountings 3 by two crossed straps 2a, 2b forming a hinge enabling a rotation by a complete revolution between the mountings, according to a “Jacob's ladder” principle.

To do this, as shown in FIG. 3b, one end 15a of a first strap 2a is fastened to a first visible face 18a of the mounting 3 and one end 15b of a second strap 2b to a second visible face 18b of the mounting, each of the ends being provided with a first 7a and a second 7b respective housing, the opening 9a, 9b for passing rod 5a, 5b of each of the housings being positioned facing the screwing opening 21b, 21a of each other of the housings, so as to enable the passage of a rod 5a, 5b in each of the housings 7a, 7b and the screwing thereof in each other of the housings 7b, 7a.

What is claimed is:

1. A motor vehicle trim component, the component comprising:
a strap,
a mounting for the strap,
a means for assembling one end of the strap to the mounting, the means being provided with a rod and an anchor head protruding radially from the rod, the component wherein it further comprises a housing concealing the end, the housing comprising:
a bottom wall provided with an opening for passing the rod, the head being postionable towards the wall,
overhanging walls extending vertically in line with said bottom wall, so as to define a space for accommodating the head,
a cover for closing the space in order to conceal the head.

2. A component according to claim 1, wherein the housing comprises interlocking means for holding the cover in the closed position.

3. The component according to claim 1, wherein the housing is made of moulded plastic material, the cover being connected to the rest of the housing by a thin material zone obtained from the moulding, the zone forms a flexible hinge.

4. The component according to claim 1, wherein the housing is based on moulded plastic material, the end of the strap being overmoulded by the housing.

5. The component according to claim 4, wherein the strap extends on either side of the opening, the strap being provided with a hole for passing the rod, the rod passes both via the hole and the opening.

6. The component according to claim 1, wherein an overhanging wall is provided with a slot through which the strap passes, the strap being provided at the end with a hole for passing the rod, the rod passes both via the hole and the opening.

7. The component according to claim 6, wherein the hole is provided with a reinforcement eyelet.

8. The component according to 1, wherein the cover is arranged flush with a visible face of the mounting.

9. The component according to claim 1, wherein a housing comprises a lateral protuberance provided with an opening for screwing a threaded rod of an assembly means in screw form.
